(19) United States
(12) Patent Application Publication
(10) Pub. No.: US 2015/0302009 A1
(43) Pub. Date: Oct. 22, 2015

(54) Adaptive Media Library for Application Ecosystems

(71) Applicant: Google Inc., Mountain View, CA (US)

(72) Inventors: Philip Thomas Henderson, Sunnyvale, CA (US); Sajid Mahmood Siddiqi, Fremont, CA (US)

(73) Assignee: Google Inc., Mountain View, CA (US)

(21) Appl. No.: 14/257,205

(22) Filed: Apr. 21, 2014

(51) Int. Cl. G06F 17/30; G06N 99/00

(52) U.S. Cl. CPC G06F 17/3005; G06N 99/005

(57) ABSTRACT

Systems and techniques are provided for an adaptive media library for application ecosystems. A request may be received for a media item from an application. The request may include an application state of the application and user data associated with a user of the application. A media item may be selected from among media items in a media database based on the application state, the user data, media selection criteria, and metadata for one or more media items. The selected media item may be sent to the application. User feedback may be received about the media item from the application. The user feedback may be stored as user feedback data. The media selection criteria may be updated based on the user feedback data and the metadata for the media items. An effect of the media items on the user may be predicted. The media item with the greatest predicted effect among the subset of media items may be selected.

### BACKGROUND

Applications created by developers for distribution within an application ecosystem, such as, for example, a game, may not only need to implement functionality well, but may also need to have a great deal of professional ‘polish’, such as, for example, strong visual animations and enjoyable background music, in order to do well. Users may be more inclined to install, use, and pay for applications that appear more professional. However, adding media polish to an application may require a different skill set than application development. This may result in independently-developed applications being less polished and lower quality than applications created by larger application developers. The lack of polish in an application may worsen the experience for users, and reduce the application's monetization for both the developer and the owner of the application ecosystem. Additionally, there may be large variety of musical tastes among users of the application ecosystem. Good, professional music in an application may still not appeal to a large number of users, as those users may prefer different styles of music.

Some services may provide musical tracks that are freely available to all video creators. This may allow amateur video producers to use higher quality music, but their choice of music in the video is still fixed. Application developers may pay others to produce professional visualizations and music for their applications, but the choice of music may be fixed across all users.

### BRIEF SUMMARY

According to an embodiment of the disclosed subject matter, a request may be received for a media item from an application. The request may include an application state of the application and user data associated with a user of the application. A media item may be selected from among media items in a media database based on the application state, the user data, media selection criteria, and metadata for one or more media items. The selected media item may be sent to the application.

User feedback may be received about the media item from the application. The user feedback may be stored as user feedback data. The media selection criteria may be updated based on the user feedback data and the metadata for the media items. The updated media selection criteria may be stored. Selecting a media item may include predicting an effect of a subset of the media items on the user, and selecting the media item with the greatest predicted effect among the subset of media items. The effect may include one of increasing usage time of the application and increasing monetization of the application. Predicting the effect may include using a machine learning system. Updating the media selection criteria may include using a machine learning technique. A machine learning system may be linear regression, logistic regression, a neural network, a stochastic model, or a Markov model.

The user feedback may include a rating of the media item, an instruction to skip the media item, a request for additional media items similar to the media item, a bookmark applied to the media item, a change in usage time of the application, a change in input frequency to the application, an in-application purchase, and a purchase of the application. The application state may include an identifier for the application, a developer preference for a type of media item to be used in the application, a stage of the application being interacted with by the user, and a frequency of input into the application. The metadata for a media item may include an author, total running time, volume, spectrogram, melody, beats, speech recognition and the presence of vocals, language, and genre.

A media item in the media database may be uploaded by a first content creator, and another media item in the media database may be uploaded by a second content creator. The application may be distributed through an application ecosystem, and the media database may be stored on a server operated in conjunction with the application ecosystem.

The user data may include demographic data for the user using a computing device running the application, data from an umbrella account logged-in to by the user on the computing device running the application, location data, and current time data.

According to an embodiment of the disclosed subject matter, a means for receiving a request for a media item from an application, where the request may include an application state of the application and user data associated with a user of the application, a means for selecting a media item from among media items in a media database based on the application state, the user data, media selection criteria, and metadata for one or more media items, a means for sending the selected media item to the application, a means for receiving user feedback about the media item from the application, a means for storing the user feedback as user feedback data, a means for updating the media selection criteria based on the user feedback data and the metadata for one or more media items, a means for storing the updated media selection criteria, a means for predicting an effect of at least a subset of the media items on the user, and a means for selecting the media item with the greatest predicted effect among the subset of the media items, where the effect may be one of increasing usage time of the application and increasing monetization of the application, are included.

A means for sending a request for a media item from an application to an adaptive media library, where the request may include an application state and user data, a means for receiving by the application a media item from the adaptive media library, where the received media item may be a media item selected from among media items in a media database, and a means for presenting the received media item in the application, where the media item is presented in conjunction with the functionality of the application, are also included.

Systems and techniques disclosed herein may allow for an adaptive media library for application ecosystems. Additional features, advantages, and embodiments of the disclosed subject matter may be set forth or apparent from consideration of the following detailed description, drawings, and claims. Moreover, it is to be understood that both the foregoing summary and the following detailed description are examples and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows an example system suitable for an adaptive media library for application ecosystems according to an implementation of the disclosed subject matter.

FIG. 2 shows an example arrangement for an adaptive media library for application ecosystems receiving media items according to an implementation of the disclosed subject matter.

FIG. 3 shows an example arrangement for an adaptive media library for application ecosystems sending a media item to an application according to an implementation of the disclosed subject matter.

FIG. 4 shows an example arrangement for an adaptive media library for application ecosystems generating media selection criteria with machine learning according to an implementation of the disclosed subject matter.

FIG. 5 shows an example of a process for sending a media item to an application according to an implementation of the disclosed subject matter.

FIG. 6 shows an example of a process for receiving a media item at an application according to an implementation of the disclosed subject matter.

FIG. 7 shows an example of a process for updating media selection criteria with machine learning according to an implementation of the disclosed subject matter.

FIG. 8 shows a computer according to an embodiment of the disclosed subject matter.

FIG. 9 shows a network configuration according to an embodiment of the disclosed subject matter.

### DETAILED DESCRIPTION

An adaptive media library for application ecosystems may allow for applications to use professionally made music that has been selected based on user preferences, resulting in an improved user experience. The improved user experience may result in higher levels of user engagement with an application, including longer usage time and better monetization of the application. The adaptive media library may be hosted on a computer, such as a server run by the owner or operator of an application ecosystem, and may include a media database for storing media items, such as, for example, music tracks, and a media selector for selecting the media items to provide to applications being run by users on the users' computing devices, or applications being run on a separate computing device with an interface on the user's computing device. The media selector may use any suitable machine learning system, trained with any suitable machine learning technique, to evaluate data about the media items and user behavior when exposed to media items within applications in order to make better choices of media items to send to applications. An application developer may create an application using an Application Programming Interface (API) or other component to allow the application to request and receive music from the adaptive media library.

The adaptive media library may include a media database. Content creators, such as, for example, individual musicians, composers, DJ's, and bands, may upload media items to the media database. Metadata pertaining to each media item may be ascertained, either automatically by the computer hosting the media database, using, for example, any suitable music information retrieval technique, or based on manual entry by the content creator. For example, when a music track is uploaded to the media database, music information retrieval techniques may be used to determine metadata for the music track, including, for example, author, total running time, volume, spectrogram, melody, beats, speech recognition and the presence of vocals, language, and genre. A content creator may receive compensation when a media item uploaded to the media database by the content creator is sent to an application by the adaptive media library, or used in the application after being received from the adaptive media library.

A developer who develops an application for distribution through the application ecosystem that includes that adaptive media library may use an API or other component to cause the application to request and receive media items from the adaptive media library. The adaptive media library may be made available to any application distributed through the application ecosystem. For example, a developer may create a game, and instead of including music with the game the developer may use the API to cause the game to request and receive music tracks from the adaptive media library for playback during gameplay. The developer may include criteria or recommendations for the types of media items that the adaptive media library can send to the application. For example, the developer may specify a whitelist or blacklist for media items that can or cannot be used in their application and preferences for the properties of media items used at various points in the application. For example, the developer of a game may indicate that music used at certain points in the game should have a higher number of beats per minute, while music used at other points should have a lower number of beats per minute, or music used on an introduction screen should be instrumental only, while music used during a game ending screen should have vocals. The adaptive media library may consider the developer's preferences when selecting media items to send to the developer's application, and may be able override developer preferences if, for example, the preferences are too restrictive based on the media items available in the media database.

The adaptive media library may also consider user preferences when selecting media items to send to an application being used by the user. For example, the user's demographic data may be used to determine which media items may appeal to the user. The user may have preferences for certain types of media items, for example, specific genres of music, which may be determined through the user's interaction with other aspects of the application ecosystem and an umbrella ecosystem. The umbrella ecosystem may be a larger ecosystem of which the application ecosystem is a component, and may include data on, for example, the user's internet searches, video services searches, and music service searches. The user may opt-in to allow the adaptive media library to use any available data about the user and the user's preference when selecting media items, or may elect to keep the data private. The adaptive media library may also consider other context data regarding the application being used, such as the location of the computing device running the application and the current time. For example, the adaptive media library may take into account the actual geographic location of the computing device running the application, and the how that location relates to the user, for example, whether the user is using the computing device at home, at work, or is travelling. The current time, such as time of day, day of week, month, year, and so on, may also be considered by the adaptive media library.

The adaptive media library may apply a machine learning system to the user preferences, developer preferences, and other data about the state of the application that has requested a media item in order to select the media item to be provided to the application. The machine learning system may be, for example, linear regression, logistic regression, neural networks, stochastic models, Markov models, or any other suitable system. The machine learning system may be used to predict which media item will achieve the greatest desired effect on the behavior of the user when sent to the application in response to the application's request. The desired effect may be, for example, to increase the amount of time the user spends using the application, or the amount of money the user spends in or on the application. Upon receiving a request for a media item from an application, the adaptive media library may make predictions for all, or some subset of, the media items in the media database by applying the machine learning system to the data received from the application and the metadata about the media items in the media database. The media item with the greatest predicted effect on the behavior of the user may be the media item the adaptive media library selects and sends to the requesting application for presentation to the user.

Media items received from the adaptive media library by applications may be presented to users. For example, a game may request a music track from the adaptive media library to play during a specified section of the level the user is currently on. The game may receive a music track selected by the adaptive media library, and play the music track on the user's computing device when the user reaches the specified section of the current level. The media items received from the adaptive media library may be presented to the user in the same manner as another media items used by the application, for example, music tracks may be played in the same manner as if the music track were included with the application originally.

During use of an application, a user may give feedback regarding the media items being provided to the application from the adaptive media library and presented to the user by the application. For example, the user may be able to rate the music tracks used in an application during gameplay, or may have the ability to skip music tracks they do not enjoy and bookmark or otherwise request more of music tracks they do enjoy. The user feedback may also be based on the user's usage of the application in the presence of different media items. For example, the user may be more actively engaged with a game, as determined by the frequency of user input, when the game uses certain music tracks from the adaptive media library, and less engaged during other music tracks. The user may also make a purchase, either within an application, or of the application itself, proximal to exposure to certain media items, indicating the user's enjoyment of the media items. Feedback from the user during the use of an application may affect the media items sent to the application by the adaptive media library. For example, if the rate of a user's input into the application is increasing, the adaptive library may select a music track with a faster tempo to send to the application to match the user's activity. The user feedback may be correlated and stored with data about the user, such as demographic and preference data, and data about the application, such as the state of the application when the application was sent the media item to which the user feedback relates.

The user's feedback regarding the media items may be sent to the adaptive media library, which may apply any suitable machine learning techniques to the user feedback, the metadata about the media items, data about the application being used, such as, for example, name, publisher, and genre, data about the user and the user's preferences, and data about other user's usage of the application and response to media items. The machine learning techniques used may be appropriate to the machine learning system used by the adaptive media library, and may include linear regression, logistic regression, neural networks, stochastic models, Markov models, or any other suitable techniques. The machine learning techniques may be used to train the machine learning system to make predictions about which media items from the adaptive media library will have the greatest desired effects on the different users of different applications, for example, increasing user enjoyment of and engagement with the application, increasing user's usage time of the application and the monetization of the application. The machine learning techniques may be run at regular intervals, and be applied to all of the media items in the media database and all of the applications in the application ecosystem that make use of the adaptive media library.

The adaptive media library may use other statistical evaluation techniques to determine the effect different media items have when sent to different applications used by different users. For example, the adaptive media library may designate a group of users of an application as a control group for the application, and provide the control group's applications with default media items that have not been selected by the machine learning system. The user feedback from the control group may be compared to the feedback from other users of the application who receive media items selected by the adaptive media library based on machine learning system predictions. User feedback from the control group of users may be compared to the feedback from the users exposed to media items selected based on machine learning to determine if the media item selections made by the machine learning system have any effect on user feedback, for example, increasing user engagement, usage time, or monetization when compared to users exposed only to default media items in the same application.

To prevent gaps in the use of media items by an application, and to present a more polished experience, various techniques may be used to ensure that an application always has access to an appropriate media item even when access to the adaptive media library is temporarily disrupted. For example, an application that has been resumed may start playing the same music track that was playing when the application was last exited, as the music track may be cached on the user's computing device. Media items may also be sent to a user's application in advance, for example, with the next two music tracks being sent to a game so that the music in the game won't cut off if a connection to the server hosting the adaptive media library is lost. Users may opt-out of usage of the adaptive media library or some aspects thereof. For example, a user may opt-out of receiving media items from the adaptive media library when the user's computing device is using a network connection with limited or expensive bandwidth, such as, for example, a cellular network connection. The user may choose to have the computing device receive media items from the adaptive media library when the computing device is using a connection with greater, cheaper, bandwidth, such as a WiFi network connection. The adaptive media library may use the WiFi connection to send the user's computing device the most popular media items for the user's applications, so that the media items may be available to use in the applications when the computing device is not connected via WiFi.

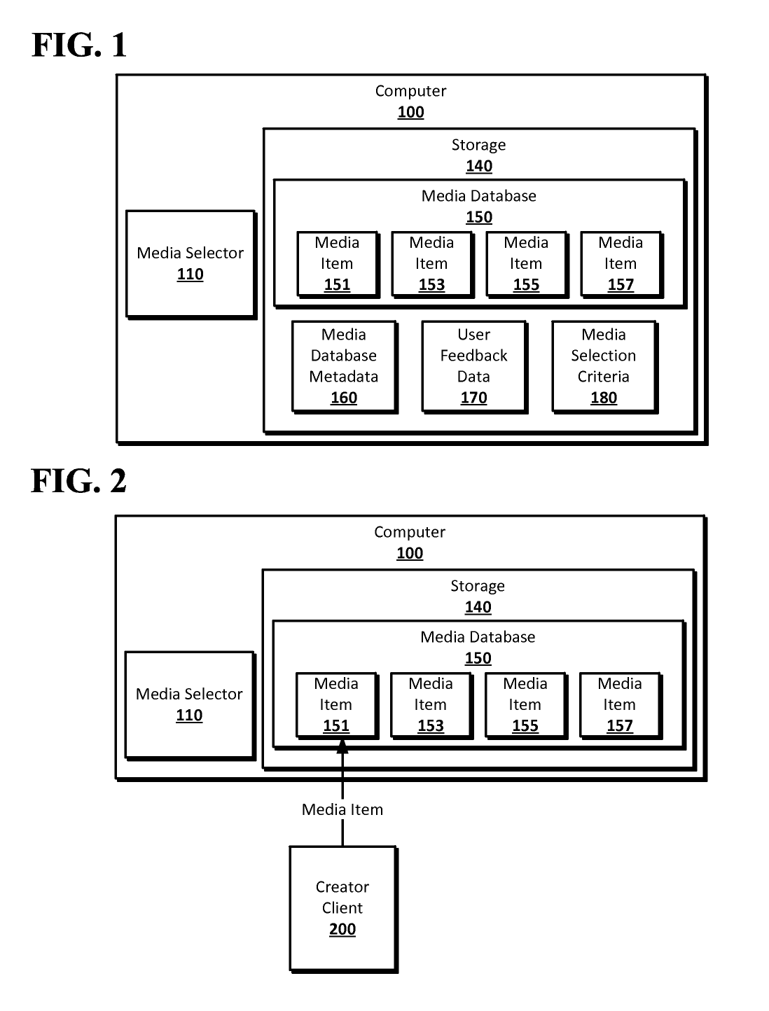

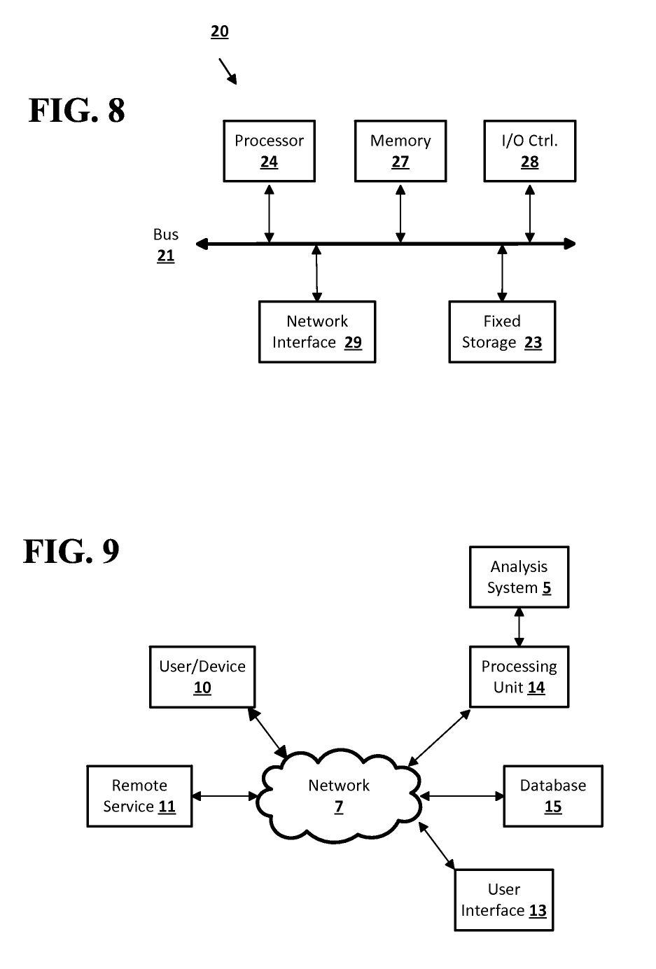

FIG. 1 shows an example system suitable for an adaptive media library for application ecosystems according to an implementation of the disclosed subject matter. A computer 100 may include a media selector 110 and storage 140 for implementing an adaptive media library. The computer 100 may be any suitable device, such as, for example, a computer 20 as described in FIG. 8, for implementing the media selector 110 and the storage 140. The computer 100 may be a single computing device, or may include multiple connected computing devices, and may be, for example, a server that is part of an application ecosystem. The storage 140 may include a media database 150, which may store media items 151, 153, 155, and 157. The storage 140 may also include media database metadata 160, user feedback data 170, and media selection criteria 180. The media selector 110 may select and send media items, such as the media items 151, 153, 155 and 157, from the media database 150 based in part on the media selection criteria 180. The media selector 110 may also generate and update the media selection criteria 180 based on the media database metadata 160 and the user feedback data 170. The storage 140 may store the media database 150, media database metadata 160, user feedback data 170, and media selection criteria 180 in any suitable format.

The media database 150 may store the media items 151, 153, 155, and 157. The media items 151, 153, 155, and 157 may be, for example, music tracks. The media items stored in the media database 150 may be from any number of content creators. The media selector 110 may select from among the media items stored in the media database 150, such as media items 151, 153, 155, and 157, when sending media to an application being used by a user on a computing device that may be connected to the computer 100 via any suitable network connection.

The media database metadata 160 may be data stored in any suitable format about the media items 151, 153, 155, and 157 in the media database 150. For example, the media database metadata 160 may store author, total running time, volume, spectrogram, melody, beats, speech recognition and the presence of vocals, language, and genre, for each of the media items in the media database 150 that is a music track. The data about media items stored in the media database metadata 160 may be automatically detected, for example, by the computer 100, or may be entered manually by the creator of individual media items. The media database metadata 160 may store data regarding the usage of the media items in the media database 150, for example, tracking how often media items are used and which applications they are used in. This may allow for compensation of the creators of the media items based on the frequency and types of uses of their media items.

The user feedback data 170 may be data stored in any suitable format regarding feedback received from users who use applications that receive media items from the media database 150. For example, direct user feedback, such as rating of media items by the user, may be stored in the user feedback data 170 along with indirect user feedback, such as measures of user engagement and activity within an application while the application is presenting certain media items and monetization of the application. The user feedback data 170 may correlate user actions or behavior with the media items that were being presented to the user at the time of the actions. For example, if the user makes an in-application purchase while the application is playing a music track from the media database 150, the user feedback data 170 may store data recording the event, including the music track that was playing, the identity of the application and state of the application when the music track was requested, and demographic data about the user and preference data for the user if allowed by the user.

The media selection criteria 180 may be data stored in any suitable format that may be used by the media selector 110 to select media items from the media database 150 to send to applications. The media selection criteria 180 may be, for example, data used by any suitable machine learning system, such as, for example, weights for a neural network or nodes and transition probabilities for a Markov Model. The media selector 110 may implement any suitable machine learning system for use with the media selection criteria 180 to predict which media items may have a desired effect, for example, increasing usage time or monetization, when presented to a user in an application. The media selection criteria 180 may be created and updated by the media selector 110 based on the media database metadata 160 and the user feedback data 170, using any suitable machine learning technique.

FIG. 2 shows an example arrangement for an adaptive media library for application ecosystems receiving media items according to an implementation of the disclosed subject matter. A creator client 200 may be a computing device, such as, for example, a smartphone, tablet, laptop, or desktop computer, used by a content creator, such as, for example, a musician or composer. The creator client 200 may be connected to the computer 100 in any suitable manner using any suitable network connection. For example, an application distributed through the application ecosystem may be installed on the creator client 200 and used to access the media database 150 on the computer 100. The creator client 200 may send, or upload, a media item, for example, the media item 151, to the media database 150. The media item 151 may be, for example, a music track created by the content creator. The content creator may use the creator client 200 to enter metadata about the media item 151 into the media database metadata 160, or the computer 100 may automatically analyze the media item 151, for example, with a media analyzer that may be part of the media selector 110 or may be a separate component of the adaptive media library, and store the metadata in the media database metadata 160.

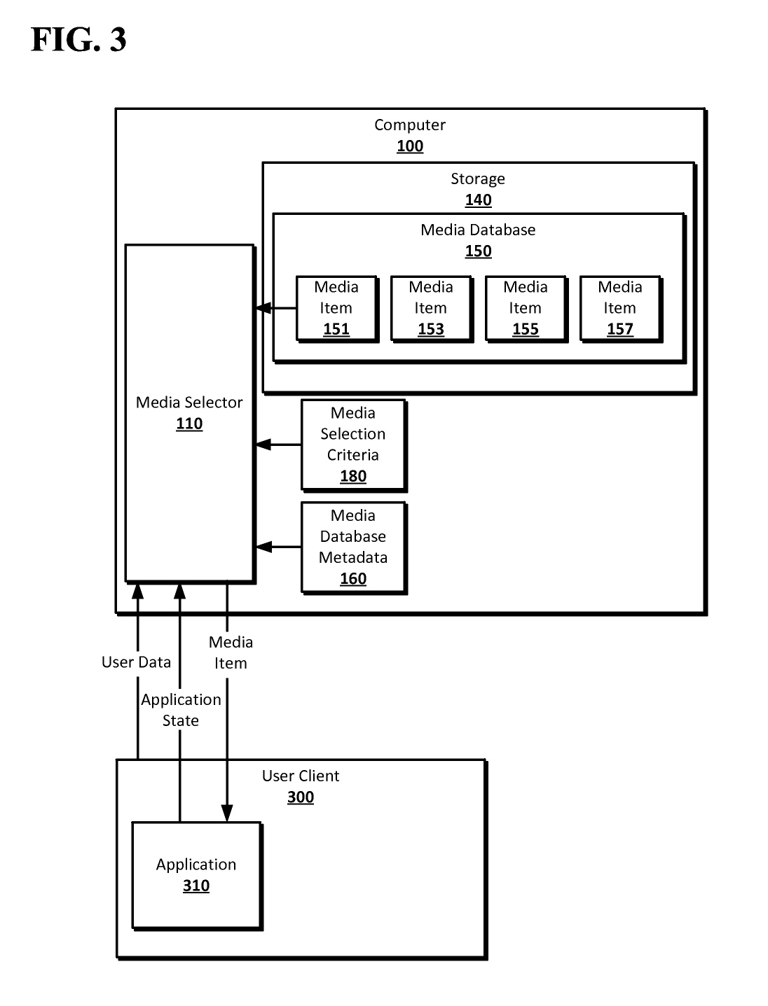

FIG. 3 shows an example arrangement for an adaptive media library for application ecosystems sending a media item to an application according to an implementation of the disclosed subject matter. A user client 300 may be a computing device, such as, for example, a smartphone, tablet, laptop, or desktop computer, used by a user with an account in an application ecosystem. The application 310 may be an application distributed through the application ecosystem that may be installed on the user client 300. The application 310 may incorporate an API or other component to allow the application 310 to receive media items from the adaptive media library for use within the application 310. For example, the application 310 may be a game, and the developer may choose to use music tracks from the media database 150 as the soundtrack to the game. The application 310 may request media items from the media database 150 as needed. For example, a game may request music tracks from the database 150 to ensure that there is always music playing while the user is playing the game. The application 310 may be run directly on the user client 300, or may run on a remote computing device, such as a cloud server, with an interface on the user client 300.

The user client 300 may be able to access the computer 100 using any suitable network connection, such as, for example, a cellular or WiFi connection. The application 310 may be run on the user client 300, and may request a media item from the media database 150. The request from the application 310 may not be for a specific media item, but may identify the type of media item. For example, the application 310 may request that a music track be selected from the media database 150. User data and application state data may be sent from the application 310 and the user client 300 to the media selector 110 on the computer 100. The user data may be, for example, demographic data about the user, media preferences for the user, or any other data the users permits to be used from an application ecosystem or umbrella ecosystem account logged-in to on the user client 300. The application state data may include the current state of the application 310, identifying data for the application 310, and developer preferences for media items to be used with the application 310 generally and based on the current state of the application 310. Other context data regarding the application 310 and the user client 300 such as the location of the user device 300 running the application 310 and the current time, may be included in the user data or the application state data.

For example, if the application 310 is a game, the current state of the application 310 may include what level of the game the user is on, where in the level user is, the state of the user's character within the game, and how the user is interacting with the game. The identifying data may include the name of the application 310 and the developer or other party involved in the creation and distribution of the application 310. The developer preferences may include general preferences for the media items used with the application 310, such as a whitelist or blacklist, and preferences based on the state of the application 310, for example, preferences based on which level of a game a user is on. For example, the developer of a game may specify a preference for music tracks with faster tempos for use at a specified location within a specified level in the game. The developer preference may be sent to the media selector 110 as part of the application state data when the application 310 requests a music track that will be played at the specified location in the specified level, for example, when the user is about to reach the specified location in the specified level.

The media selector 110 may receive the application state and user data from the user client 300. The media selector 110 may combine the application state and the user data with the media selection criteria 180 and the media database metadata 160 to predict which media item from the media database 150 will achieve a desired effect when sent to the user client 300 for use in the application 310. The media selector 110 may select the media item predicted to have the greatest effect on the user, for example, to increase the user's usage time of the application 310 by the greatest amount. The prediction made by the media selector 110 may be based on any suitable machine learning system trained with any suitable machine learning technique. The selection of the media item by the media selector 110 may incorporate both the preferences of the user of the user client 300 and feedback from other users as reflected in the media selection criteria 180, which may be based in part on the user feedback data 170, along with the application state. This may allow the media items presented to the user of the user client 300 to be customized to the user while still being selected to achieve the greatest desired effect on the usage time, enjoyment, monetization, or any other suitable metric for user engagement with the application 310.

The media item selected by the media selector 110 may be sent to the user client 300 for use in the application 310. The media selector 110 may predict that the media item 151 may have the greatest effect on the user of the user client 300 running the application 310. The media selector 110 may send the media item 151 to the user client 300, and the application 310 may then present the media item 151 to the user in an appropriate manner. For example, the application 310 may be a game, and the media item 151 may be a music track selected by the media selector 110 for use in the current level of the game. The game may play the music track either immediately upon receipt of the music track, when the current music track has finished playing, or at another moment defined by the developer. The application 310 may request media items from the media database at any suitable time and interval.

The media selector 110 may select each media item sent to the user client 300 anew at each request by the application 310. This may result in the application 310 receiving different media items even when the application 310 sends the media selector 110 the same or similar application state data. For example, a game may receive a different music track from the media database 150 on different playthroughs of the same level of the game. For example, on a first playthrough on user client 300, the game may receive the media item 151, which may be a music track, to play at the beginning of the first level of the game. On a second playthrough on the user client 300, the game may receive the media item 155, which may be a different music track than the media item 151, to play at the beginning of the first level. The change in the media item sent to the application 310 may be the result of changes in the user data sent from the user client 300, changes in the user feedback data 170 as a result of feedback from the user of the user client 300 and other users of the application 310 as reflected in changes to the media selection criteria 180 made by the machine learning techniques used by the media selector 110, updated developer preferences for the application 310, and the addition or subtraction of media items from the media library 150.

Additionally, different users with different user clients may receive different media items for the same applications. For example, a second user client may use the application 310, and may receive a different media item from the user client 300 at the same or a similar point in the application 310. The difference in media items received by copies of the same application 310 being used on different user clients by different users may be the result of differences in user data between the users, as different users may have different preferences for media items reflected in their user data. For example, the user data for the user of the user client 300 may cause the media selector 110 to predict that a music track with a fast tempo will have the greatest desired effect on the user when presented during a first level of a game, while user data for a user of a second user client may cause the media selector 110 to predict that a music track with a slower tempo will have the greatest desired effect on the user of the second user client when presented during the first level of the same game. Changes in the media selection criteria 180 between uses by the different users, updated developer preferences for the application 310, and the addition or subtraction of media items from the media database 150 may also result in different users receiving different media items from the media database 150 for use at the same points in copies of the same application 310.

The user may supply feedback to the computer 100 from the user client 300 about the media items selected by the media selector 110 and presented by the application 310. For example, the application 310 may present the media item 151, which may be a music track. The user may be able to rate the media item 151 within the application 310, skip the media item 151, request more media items similar to the media item 151, or bookmark the media item 151, thereby providing direct feedback that can be stored in the user feedback data 170, by, for example, the media selector 110. The user may also be able to provide indirect feedback, for example, by not skipping the media item 151, demonstrating increased engagement with the application 310 during the presentation of the media item 151, or making a purchase related to the application 310 contemporaneous with or proximal to the presentation of the media item 151. Indirect feedback may also be stored in the user feedback 170. For example, if the user makes an in-application purchase in the application 310 proximal to the presentation of the media item 151, data indicating the purchase and its relation to the media item 151 may be stored in the user feedback data 170.

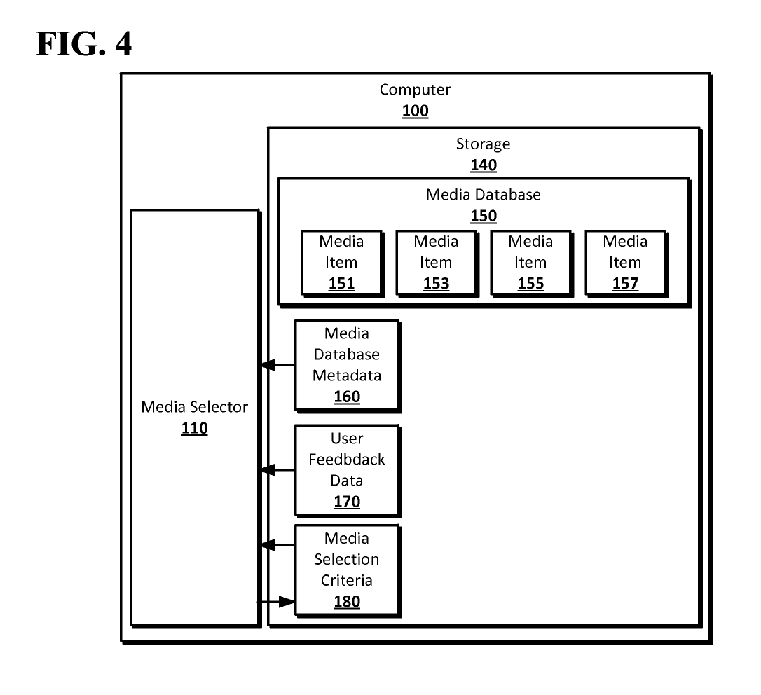

FIG. 4 shows an example arrangement for an adaptive media library for application ecosystems generating media selection criteria with machine learning according to an implementation of the disclosed subject matter. The media selector 110 may generate and update the media selection criteria 180 using the media database metadata 160 and the user feedback data 170. For example, at specified intervals, the media selector 110 may apply a machine learning technique to the media database metadata 160, the user feedback data 170, and the media selection criteria 180, in order to update the media selection criteria 180 based on recent feedback from users regarding media items presented to the users in applications that use the adaptive media library. The training input for the machine learning system used by the media selector 110 may be, for example, the application state and user data in the user feedback data 170 correlated with direct and indirect user feedback, or may be mock application state and user data. The direct and indirect user feedback in the user feedback data 170 may be used to determine the training answers, which may be probabilities or other rankings assigned to media items in the media database 150 regarding the effect the media items may have on the user.

For example, the user feedback data 170 may indicate that the media item 151 has the greatest positive effect on usage time of the application 310 by users who are male and 18-34 years old when presented during first interactive screen of the application 310. Application states and user data corresponding to the display of the first interactive screen of the application 310 to a user who is male and 18-34 years old may be used as input to the media selector 110, which may make predictions using the media database metadata 160 and the media selection criteria 180 as to which of the media items 151, 153, 155, and 157 will have the greatest positive effect on usage time. The predictions of the media selector 110 may be compared with training answers, which may indicate the media item 151 has the greatest positive effect on usage time. Machine learning techniques may be used by the media selector 110 to update the media selection criteria based on how close the predictions of the media selector 110 were to the training answers.

The use of machine learning techniques may allow the media selector 110 to better predict which media items in the media database 150 will achieve the greatest desired effect when presented to the user in an application, based on previous user reactions to the media items. For example, updating the media selection criteria 180 may result in the media selector 110 making better predictions as to which of the media items 151, 153, 155, and 157 to send to the application 310 on the user client 300 to increase the probability that the user will make an in-application purchase.

The media selector 110 may apply any suitable machine learning technique to the media database metadata 160, user feedback data 170, and media selection criteria 180, including, for example, linear regression, logistic regression, neural networks, stochastic models, and Markov models. The media selection criteria 180 may be stored in any suitable machine learning data format, including, for example, as neural network weights and Markov model nodes and transition probabilities, for use by the machine learning system used by the media selector 110 to select media items from the media database 150.

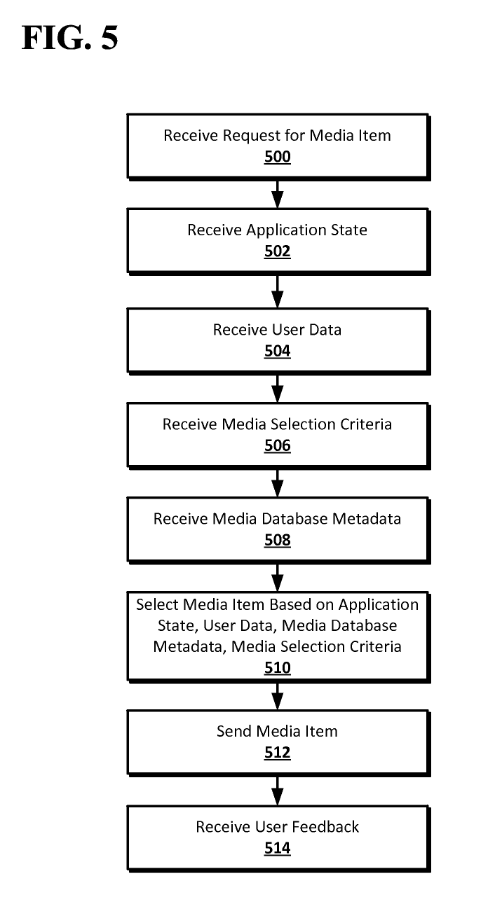

FIG. 5 shows an example of a process for sending a media item to an application according to an implementation of the disclosed subject matter. At 500, a request for a media item may be received from an application. For example the media selector 110 may receive a request from the application 310 running on the user client 300 for a media item from the media database 150. For example, the application 310 may be a game that needs a music track to play once a currently playing music track ends. The media selector 110 may receive a request from the application 310 for a music track to play next.

At 502, an application state may be received. For example, the media selector 110 may receive the application state from the application 310 running on the user client 300. The application state may include any suitable data regarding the current state of the application 310, such as, for example, identifying information for the application 310, the properties of the current display being shown by the application 310 on the user client 300, recent inputs received by the application 310 from the user client 300 from the user, recently used features or functions of the application 310, and developer preferences for the type of media items to be sent to the application 310 generally and based on the current application state. For example, the application 310 may be a game, and the application state may include the current level of the game the user is on, the user's location or progress within the current level, and the developer's preference for the type of music track to be played during the current level.

At 504, user data may be received. For example, the media selector 110 may receive user data from the user client 300. The user data may include, for example, demographic data about the user of the user client 300, and data on user preferences in media items, such as, for example, the user's music preferences. The media selector 110 may receive an identification of an umbrella ecosystem account the user has logged-in to on the user client 300, and may gather user data from the umbrella ecosystem account if permitted by the user. For example, the media selector 110 may gather data on the user's music preferences based on searches the user has performed for music and artists while logged-in to the user's umbrella ecosystem account on the user client 300 or any other computing device.

At 506, media selection criteria may be received. For example, the media selector 110 may receive the media selection criteria 180 from the storage 140. The media selection criteria 180 may be machine learning system data that can be used by a machine learning system implemented in the media selector 110.

At 508, media database metadata may be received. For example, the media selector 110 may receive the media database metadata 160 from the storage 140. The media database metadata 160 may include identifying data for the media items, such as the media items 151, 53, 155, and 157, in the media database 150, along with metadata about the media items that may allow the media selector 110 to better determine which media items to send to the application 310.

At 510, a media item may be selected based on the application state, the user data, the media database metadata, and the media selection criteria. For example, the media selector 110 may use any suitable machine learning system trained with any suitable machine learning technique to apply the media selection criteria 180 to the user data, application state, and media database metadata 160 to identify and select an appropriate media item from the media database 150. The media selector 110 may predict the effect each of the media items in the media database 150 may have on certain behaviors of the user of the application 310 on the user client 300, and select the media item predicted to have the greatest effect. For example, the media selector 110 may predict that the media item 151 will increase the user's usage time of the application 310 by one hour, the media item 153 will increase usage time by 30 minutes, and the media items 155 and 157 will decrease usage time. The media selector 110 may select the media item 151 to be sent to the user client 300 for presentation to the user by the application 310.

At 512, the media item may be sent to the requesting application. For example, the media selector 110 may send the selected media item 151 from the media database 150 to the user client 300. The sending of the media item 151 may be recorded in the media database metadata 160. This may increase the amount of data used in training the machine learning system used by the media selector 110 during updates of the media selection criteria 180, and track the usage of the media item 151 so that the creator of the media item 151, for example, the user of the creator client 200, may be compensated.

At 514, user feedback may be received. For example, the media selector 110 or other component of the adaptive media library on the computer 100 may receive user feedback about the media item 151 from the user client 300 and store the user feedback with the user feedback data 170. The user feedback received from the user client 300 may include direct feedback, such as, for example, a rating the user gave to the media item that was sent to the application 310, or indirect feedback, such as, for example, increased usage time of the application 310 by the user. The user feedback for the media item 151 may be correlated and stored with the application state and user data sent by the application 310.

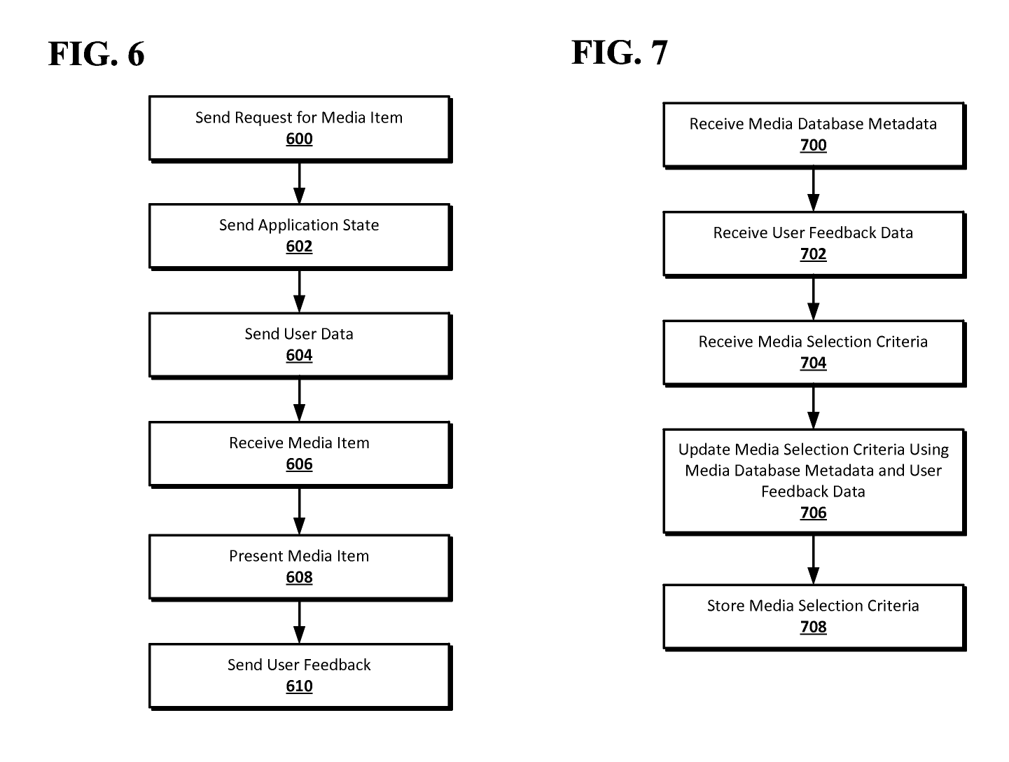

FIG. 6 shows an example of a process for receiving a media item at an application according to an implementation of the disclosed subject matter. At 600, a request for a media item may be sent. For example, the application 310 running on the user client 300 may send a request to the media selector 110 on the computer 100 for a media item from the media database 150. The application 310 may use an API that allows the application 310 to request and use media items from an adaptive media library. The request may be sent by the application 310 when the application 310 becomes aware that a media item will be needed. For example, the application 310 may need a music track to play after a currently playing music track ends, or the user of the user client 300 may have chosen to skip the currently playing music track.

At 602, an application state may be sent. For example, the application 310 may send the application state to the media selector 110. The application state may be sent over any suitable network connection between the user client 300 and the computer 100.

At 604, user data may be sent. For example, the application 310 may send the user data to the media selector 110. The user data may be sent over any suitable network connection between the user client 300 and the computer 100, and may include, for example, demographic data about the user and data from an umbrella ecosystem account logged-in to by the user on the user client 300, as permitted by the user.

At 606, the media item may be received. For example, the user client 300, and application 310, may receive the media item 151 from the media selector 110 over the network connection. The user client 300 may store the media item 151 in local storage, or may stream the media item 151 from the media database 150. The media item 151 may be made available to the application 310 running on the user client 300.

At 608, the media item may be presented. For example, the application 310 may present the media item 151 received from the media selector 110 to the user of the user client 300. For example, the media item 151 may be music track, and the application 310 may play the music track on the user client 300.

At 610, user feedback may be sent. For example, the user client 300 may send user feedback about the media item 151 gathered from the interaction between the user and the application 310 to the media selector 110. For example, the user may directly rate the media item 151, skip the media item 151, request more media items similar to the media item 151, show a change in activity within the application 310 or change in usage time of the application 310, rate the application 310, or make a purchase related to the application 310, concurrent with or proximal to being presented with the media item 151.

For example, the media item 151 may be a music track and the application 310 may be a game. While the music track is playing, the user may show an increased level of activity within the game, indicated by, for example, more frequent inputs to the application 310 from the user. The increase in the user's activity concurrent with the playing of the music track may be sent as user feedback about the media item 151.

FIG. 7 shows an example of a process for updating media selection criteria with machine learning according to an implementation of the disclosed subject matter. At 700, media database metadata may be received. For example, the media selector 110 may receive the media database metadata 160 from the storage 140.

At 702, user feedback data may be received. For example, the media selector 110 may receive the user feedback data 170 from the storage 140.

At 704, media selection criteria may be received. For example, the media selection criteria 180 may be received from the storage 140. If there is no media selection criteria 180, for example, because the adaptive media library has not yet been initialized, the media selection criteria 180 may be created in a manner appropriate to the machine learning system used by the media selector 110. For example, if the media selector 110 uses a neural network, the media selection criteria 180 may be created as randomized neural network weights.

At 706, the media selection criteria may be updated. For example, the machine learning system used by the media selector 110 may be trained using any suitable machine learning technique with the media database metadata 160 and the user feedback data 170 used as training data. The media selection criteria 180 may be adjusted in any suitable manner, for example, adjusting the weights of a neural network or the transition probabilities of a Markov model, during training with the media database metadata 160 and the user feedback data 170. The media selection criteria 180 may be updated during training to allow the media selector 110 to make better predictions about the effects the media items in the media database 150 will have when presented to various users at various usage stages of various applications. For example, the media selection criteria 180 may be updated to better predict which of the media items will better monetize gaming applications for different types of users with different user preferences.

At 708, the media selection criteria may be stored. For example, the media selection criteria 180 may be stored in the storage 140, to be accessed by the media selector 110 when selecting media items from the media database 150.

Embodiments of the presently disclosed subject matter may be implemented in and used with a variety of component and network architectures. FIG. 8 is an example computer system 20 suitable for implementing embodiments of the presently disclosed subject matter. The computer 20 includes a bus 21 which interconnects major components of the computer 20, such as one or more processors 24, memory 27 such as RAM, ROM, flash RAM, or the like, an input/output controller 28, and fixed storage 23 such as a hard drive, flash storage, SAN device, or the like. It will be understood that other components may or may not be included, such as a user display such as a display screen via a display adapter, user input interfaces such as controllers and associated user input devices such as a keyboard, mouse, touchscreen, or the like, and other components known in the art to use in or in conjunction with general-purpose computing systems.

The bus 21 allows data communication between the central processor 24 and the memory 27. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as the fixed storage 23 and/or the memory 27, an optical drive, external storage mechanism, or the like.

Each component shown may be integral with the computer 20 or may be separate and accessed through other interfaces. Other interfaces, such as a network interface 29, may provide a connection to remote systems and devices via a telephone link, wired or wireless local- or wide-area network connection, proprietary network connections, or the like. For example, the network interface 29 may allow the computer to communicate with other computers via one or more local, wide-area, or other networks, as shown in FIG. 9.

Many other devices or components (not shown) may be connected in a similar manner, such as document scanners, digital cameras, auxiliary, supplemental, or backup systems, or the like. Conversely, all of the components shown in FIG. 8 need not be present to practice the present disclosure. The components can be interconnected in different ways from that shown. The operation of a computer such as that shown in FIG. 8 is readily known in the art and is not discussed in detail in this application. Code to implement the present disclosure can be stored in computer-readable storage media such as one or more of the memory 27, fixed storage 23, remote storage locations, or any other storage mechanism known in the art.

FIG. 9 shows an example arrangement according to an embodiment of the disclosed subject matter. One or more clients 10, 11, such as local computers, smart phones, tablet computing devices, remote services, and the like may connect to other devices via one or more networks 7. The network may be a local network, wide-area network, the Internet, or any other suitable communication network or networks, and may be implemented on any suitable platform including wired and/or wireless networks. The clients 10, 11 may communicate with one or more computer systems, such as processing units 14, databases 15, and user interface systems 13. In some cases, clients 10, 11 may communicate with a user interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to web browser clients 10, and a computer-readable API or other interface is provided to remote service clients 11. The user interface 13, database 15, and processing units 14 may be part of an integral system, or may include multiple computer systems communicating via a private network, the Internet, or any other suitable network. Processing units 14 may be, for example, part of a distributed system such as a cloud-based computing system, search engine, content delivery system, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method performed by a data processing apparatus, the method comprising:
receiving a request for a media item from an application, wherein the request comprises an application state of the application and user data associated with a user of the application;
selecting a media item from among a plurality of media items in a media database based on the application state, the user data, media selection criteria, and metadata for at least one of the plurality of media items; and
sending the selected media item to the application.

2. The computer-implemented method of claim 1, further comprising:
receiving user feedback about the media item from the application; and
storing the user feedback as user feedback data.

3. The computer-implemented method of claim 2, further comprising:
updating the media selection criteria based on the user feedback data and the metadata for at least one of the plurality of media items; and
storing the updated media selection criteria.

4. The computer-implemented method of claim 1, wherein selecting a media item further comprises:
predicting an effect of at least a subset of the plurality of media items on the user; and
selecting the media item with the greatest predicted effect among the subset of the plurality of media items, wherein the effect comprises at least one of: increasing usage time of the application, increasing a rating for the application, increasing engagement with the application, and increasing monetization of the application.

5. The computer-implemented method of claim 4, wherein predicting the effect comprises using a machine learning system.

6. The computer-implemented method of claim 3, wherein updating the media selection criteria comprises using at least one machine learning technique.

7. The computer-implemented method of claim 5, wherein the machine learning system is one machine learning system selected from the group consisting of: linear regression, logistic regression, a neural network, a stochastic model, and a Markov model.

8. The computer-implemented method of claim 2, wherein the user feedback comprises at least one of: a rating of the media item, an instruction to skip the media item, a request for additional media items similar to the media item, a bookmark applied to the media item, a change in usage time of the application, a change in input frequency to the application, an in-application purchase, and a purchase of the application.

9. The computer-implemented method of claim 1, wherein the application state comprises at least one of: an identifier for the application, a developer preference for a type of media item to be used in the application, a stage of the application being interacted with by the user, and a frequency of input into the application

10. The computer-implemented method of claim 1, wherein the metadata for at least one of the plurality of media items comprises at least one of author, total running time, volume, spectrogram, melody, beats, speech recognition and the presence of vocals, language, and genre.

11. The computer-implemented method of claim 1, wherein at least one of the plurality of media items in the media database was uploaded by a first content creator, and at least one other of the plurality of media items in the media database was uploaded by a second content creator.

12. The computer-implemented method of claim 1, wherein the application was distributed through an application ecosystem, and wherein the media database is stored on a server operated in conjunction with the application ecosystem.

13. The computer-implemented method of claim 1, wherein the user data comprises at least one of: demographic data for the user using a computing device running the application, data from an umbrella account logged-in to by the user on the computing device running the application, location data, and current time data.

14. A computer-implemented method performed by a data processing apparatus, the method comprising:
receiving a request for a media item from each of a plurality of applications, each of the plurality of applications running on a separate one of a plurality of computing devices;
receiving an application state and user data from each of the plurality of applications;
selecting a media item from a media database for each of the plurality of applications, wherein the media item is selected for each one of the plurality of applications based on the application state and the user data received from the application and media selection criteria;
sending each of the selected media items to the application for which the media item was selected.

15. The computer-implemented method of claim 14, wherein selecting a media item is further based on media database metadata.

16. The computer-implemented method of claim 14, wherein one of the plurality of computing devices comprises: a tablet, a smartphone, a laptop computer, or a desktop computer.

17. The computer-implemented method of claim 14, wherein at least two of the selected media items are different media items.

18. The computer-implemented method of claim 14, wherein the media items in the media database are music tracks.

19. The computer-implemented method of claim 14, further comprising:
receiving user feedback about at least one of the selected media items from the at least one of the plurality of applications;
storing the user feedback as user feedback data;
updating the media selection criteria based on the user feedback data and media database metadata with at least one machine learning technique; and
storing the updated media selection criteria.

20. A computer-implemented method performed by a data processing apparatus, the method comprising:
sending a request for a media item from an application to an adaptive media library, wherein the request comprises an application state and user data;
receiving by the application a media item from the adaptive media library, wherein the received media item comprises a media item selected from a plurality of media items in a media database; and
presenting the received media item in the application, wherein the media item is presented in conjunction with the functionality of the application.

21. The computer-implemented method of claim 20, wherein the application is a game, the received media item is a music track, and presenting the received media item comprises playing the music track during gameplay of the game.

22. The computer-implemented method of claim 20, wherein the application is a productivity application, the received media item is a music track, and presenting the received media comprises playing the music track during usage of the functionality of the productivity application.

23. The computer-implemented method of claim 20, wherein the user data comprises data associated with a user of a computing device running the application

24. The computer-implemented method of claim 20, further comprising sending from the application user feedback about the media item to the adaptive media library.

25. A computer-implemented system for an adaptive media library comprising:
a storage comprising a media database, media database metadata, user feedback data, and media selection criteria, the media database comprising a plurality of media items;
a media selector adapted to receive a request for a media item, an application state, and user data from an application running on a computing device, select a media item responsive to the request from the media database based on the application state, user data, media database metadata, and media selection criteria, and send the selected media item to the computing device to be used by the application.

26. The computer-implemented system of claim 25, wherein the media selector is further adapted to receive user feedback from the application running on the computing device, store the user feedback in the user feedback data, and update the media selection criteria based on the media database metadata and user feedback data using a machine learning technique.

27. The computer-implemented system of claim 25, wherein the media server is further adapted to select the media item responsive to the request using a machine learning system.

28. The computer-implemented system of claim 25, wherein the user feedback data comprises at least one of: a rating of one of the plurality of media items, an instruction to skip one of the plurality of media items, a request for additional media items similar to one of the plurality of media items, a bookmark applied one of the plurality of media items, a change in usage time of an application contemporaneous with the presentation of one of the plurality of media items by the application, a rating of the application, a change in input frequency to the application contemporaneous with the presentation of one of the plurality of media items, an in-application purchase made in the application proximal to the presentation of one of the plurality of media items, and a purchase of the application proximal to the presentation of one of the plurality of media items.

29. The computer-implemented system of claim 25, wherein the media database metadata comprises at least one of author, total running time, volume, spectrogram, melody, beats, speech recognition and the presence of vocals, language, and genre, for at least one of the plurality of media items in the media database.

30. The computer-implemented system of claim 25, wherein the media database is further adapted to receive a media item uploaded by a content creator.

31. The computer-implemented system of claim 27, wherein the machine learning system is used by the media selector to predict an effect of at least a subset of the media items in the media database on behavior of a user of the application from which the request for a media item was received, and wherein the media selector is further adapted to select the media item from the media database with the greatest predicted effect.

32. A system comprising: one or more computers and one or more storage devices storing instructions which are operable, when executed by the one or more computers, to cause the one or more computers to perform operations comprising:
receiving a request for a media item from an application, wherein the request comprises an application state of the application and user data associated with a user of the application;
selecting a media item from among a plurality of media items in a media database based on the application state, the user data, media selection criteria, and media database metadata; and
sending the selected media item to the application.

33. The system of claim 30, wherein the instructions further cause the one or more computers to perform operations further comprising:
receiving user feedback about the media item from the application;
storing the user feedback as user feedback data;
updating the media selection criteria based on the user feedback data and media database metadata; and
storing the updated media selection criteria.
